(19) United States
(12) Patent Application Publication
(10) Pub. No.: US 2020/0012280 A1
(43) Pub. Date: Jan. 9, 2020

(54) AUTOMATIC DRIVING ASSISTANCE DEVICE AND METHOD THEREOF

(71) Applicant: HITACHI, LTD., Tokyo (JP)

(72) Inventor: Tao LIN, Tokyo (JP)

(73) Assignee: HITACHI, LTD., Tokyo (JP)

(21) Appl. No.: 16/503,079

(22) Filed: Jul. 3, 2019

(30) Foreign Application Priority Data
Jul. 9, 2018 (JP) 2018-130247

(51) Int. Cl. G05D 1/00; G05D 1/02

(52) U.S. Cl. CPC G05D 1/0088; G05D 1/0212; G05D 1/0278; G05D 2201/0213; G05D 1/0276

(57) ABSTRACT

A situation recognizer calculates situation recognition information on a peripheral situation of a vehicle based on sensor information indicating the vehicle's periphery, map information, and motion information indicating the vehicle's state; an experience information database including information on each function, a function achievement value indicating each function's achievement degree, and a road on which each function was executed, in association with the situation recognition information, the experience information reflecting an execution result of each function during automatic driving; a control route calculator extracts experience information corresponding to the situation recognition information from the experience information database and calculates a control route including the road where the function achievement value is high; a control determination unit which generates control method information for controlling the vehicle to execute the function on the control route; and a control executor executes the automatic driving based on the control method information.

### BACKGROUND OF THE INVENTION

### 1. Field of the Invention

The present invention relates to an automatic driving assistance device that assists automatic driving of a vehicle using sensor information, map information, and the like, and a method thereof.

### 2. Description of the Related Art

In recent years, expectations for automatic driving vehicles have increased in order to realize a safe and reliable traffic society. The automatic driving vehicles realize automatic driving travel without intervention of an operation performed by a user, for example, a recognition function of a peripheral situation using sensor information and map information, a determination function of a control method in accordance with the recognition information, and a vehicle operation function based on determination information cooperate with each other to continuously and consistently executing processing. Such automatic driving travel is expected to significantly reduce traffic accidents, which are mostly caused by human mistakes.

However, there is a functional stage, such as safety assistance and partial automatic driving, in a process to realize the function of fully automatic driving. At such a stage, performance of a sensor to be mounted, a realized function, or the like differs depending on a vehicle type. Even for one function of one vehicle type, a situation where it is difficult to control the automatic driving travel stably and consistently based on a recognition result of a sensor and a determination logic of a function may sometimes occur depending on a driving environment. If an automatic driving travel function is abruptly released or sudden wobbling driving is performed, the unstable automatic driving is performed. In this case, a user of a car (including a driver) may feel anxious, and further, there is also a risk of causing an accident if a control authority is handed over out of the driver's expectation during the travel.

Meanwhile, it is difficult for the driver to grasp information such as the entire travel-planned road sections and traffic conditions. Further, it is difficult for the driver to recognize how much an automatic driving function of a host vehicle can adapt to traffic conditions and scenes, and it is necessary to monitor automatic control with the same concentration as the case of manual driving even in the middle of implementing an automatic control function. In this case, the object and meaning of the automatic control function are lost, and thus, the stability and continuity of the corresponding function are strongly required.

When an automatic driving vehicle as described above travels on a road, it is necessary to determine a control method in consideration of various conditions such as a road shape, a traffic volume, a weather, a time zone, and map information. However, there are a large number of combinations with conditions at each time, and it is extremely difficult to provide the automatic driving vehicle with a determination function that can cope with every situation.

As a related art concerning prevention of automatic driving travel cancellation, sudden braking, sudden rotation, or the like in an automatic driving vehicle, JP 2017-117079 A discloses a technique of performing automatic control with a configuration in which obstacle information including a position of an obstacle on a map is obtained, a plurality of reference points, used as references at the time of implementing automatic driving assistance in a host vehicle, are set on a planned travel route of the host vehicle, and a target speed and a priority of the host vehicle are generated for each reference point as assistance information to be used for the automatic driving assistance implemented in the host vehicle traveling on the planned travel route based on the planned travel route and the obstacle information. JP 2017-032422 A discloses a technique of performing driving assistance through automatic driving travel or the like by performing a route search reflecting a ratio of vehicles having been assisted by a travel assistance device to search for a route advantageous to a vehicle equipped with the travel assistance device.

### SUMMARY OF THE INVENTION

In JP 2017-117079 A, on a premise that the planned travel route is present, a state of the obstacle on the planned travel route is grasped to feed back the grasped content to a control system in advance, thereby performing settings to implement stable and continuous control. However, it is difficult for sensors and functions installed in the vehicle to sense and avoid all obstacles until fully automatic driving is realized, and thus, it is not sufficient to reduce unexpected sudden cancellation of a function and occurrence of unstable control in the corresponding route. In JP 2017-032422 A, a route is set in route calculation using the ratio of the vehicles having been assisted by the travel assistance device of automatic driving as cost of a route. Practically, however, an evaluation on result information (whether or not stable and continuous travel assistance has been performed) assisted by the travel assistance device of the corresponding vehicle on the route and route evaluation result information of vehicles equipped with the same safe driving assistance function, and the like are used to generate a route that is not shared, and thus, it is not sufficient to reduce the sudden function cancellation and the occurrence of unstable control.

An object of the invention is to calculate a control route adapted to a function of an automatic driving vehicle based on experience information reflecting an execution result of the function during automatic driving travel of the automatic driving vehicle.

In order to solve the above-described problems, the invention is provided with: a situation recognition unit which calculates situation recognition information on a peripheral situation of a vehicle based on sensor information indicating information on a periphery of the vehicle performing automatic driving, map information including a travel route of the vehicle, and motion information indicating a state of the vehicle; an experience information database which includes information on at least a plurality of functions, a function achievement value indicating an achievement degree of each of the plurality of functions, and a road on which each of the plurality of functions has been executed, as experience information reflecting execution results of the plurality of functions during automatic driving travel of the vehicle, and in which the experience information is recorded in association with the situation recognition information; an experience information extraction unit which searches the experience information database based on the situation recognition information calculated by the situation recognition unit, and extracts the experience information corresponding to the situation recognition information from the experience information database; a control route calculation unit which calculates a control route including the road of which the function achievement value is high, the route being a route when executing at least one of the plurality of functions based on the experience information extracted by the experience information extraction unit; a control determination unit which determines a control method for controlling the vehicle to execute at least one of the plurality of functions on the control route calculated by the control route calculation unit, and generates control method information on the determined control method; and a control execution unit which operates the vehicle based on the control method information generated by the control determination unit to execute the automatic driving of the vehicle.

According to the invention, it is possible to calculate the control route adapted to the function of the automatic driving vehicle based on the experience information reflecting the execution result of the function during the automatic driving travel of the automatic driving vehicle. Objects, configurations, and effects other than the above-described ones will be apparent from the following description of embodiments.

### BRIEF DESCRIPTION OF THE DRAWINGS

FIG. 1 is a configuration diagram of an automatic driving system according to a first embodiment of the invention;

FIG. 2 is a physical configuration diagram of an automatic driving control device according to the first embodiment of the invention;

FIG. 3 is a configuration diagram illustrating a configuration example of a control experience distribution information table according to the first embodiment of the invention;

FIG. 4 is a configuration diagram illustrating a configuration example of a road shape position information table according to the first embodiment of the invention;

FIG. 5 is a configuration diagram illustrating a configuration example of a lane shape position information table according to the first embodiment of the invention;

FIG. 6 is a configuration diagram illustrating a configuration example of a control function response route information table according to the first embodiment of the invention;

FIG. 7 is a configuration diagram illustrating a configuration example of an environment details information table according to the first embodiment of the invention;

FIG. 8 is a configuration diagram illustrating a configuration example of a time information table according to the first embodiment of the invention;

FIG. 9A is a flowchart for describing a control route calculation process of the automatic driving system according to the first embodiment of the invention;

FIG. 9B is a flowchart for describing the control route calculation process of the automatic driving system according to the first embodiment of the invention;

FIG. 10 is a flowchart for describing an experience information registration process of the automatic driving system according to the first embodiment of the invention;

FIGS. 11A and 11B are views illustrating setting examples of a travel route, in which FIG. 11A is a travel route view illustrating a setting example of a travel route when an experience information database is not used, and FIG. 11B is a travel route view illustrating a setting example of a travel route of the automatic driving system according to the first embodiment of the invention; and

FIG. 12 is a configuration diagram illustrating a configuration example of an automatic driving system according to a second embodiment of the invention.

### DESCRIPTION OF THE PREFERRED EMBODIMENTS

Hereinafter, embodiments will be described with reference to the drawings.

### First Embodiment

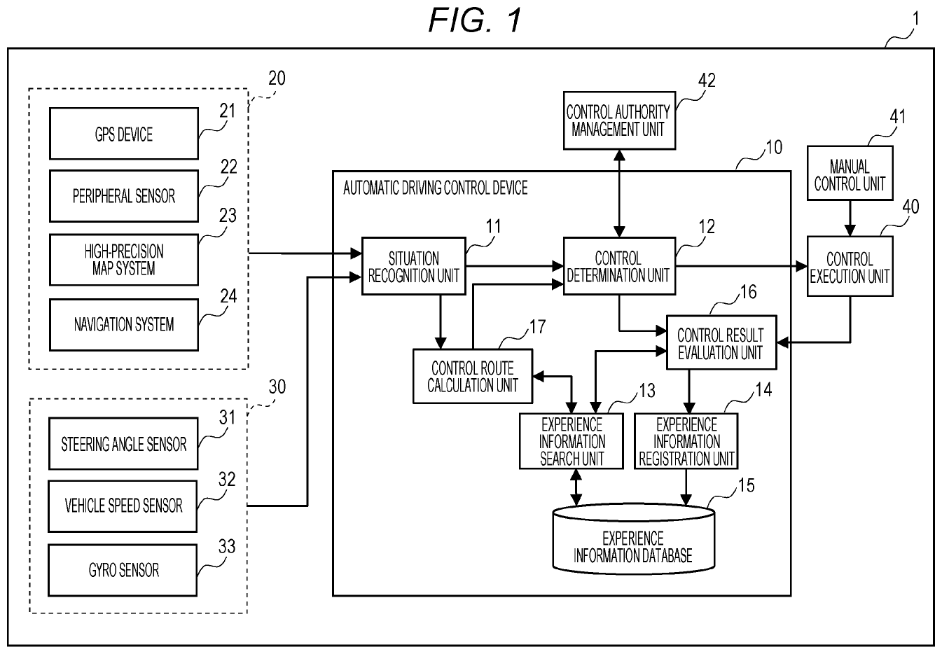

A first embodiment of the invention will be described with reference to FIGS. 1 to 11.

FIG. 1 is a configuration diagram of an automatic driving system according to the first embodiment. In FIG. 1, the automatic driving system according to the present embodiment includes an automatic driving control device 10, a sensor map information group 20, a vehicle motion information group 30, a control execution unit 40, a manual control unit 41, and a control authority management unit 42. At this time, the automatic driving system is assumed to provide automatic driving travel as the automatic driving control device 10 mounted inside a vehicle (automatic driving vehicle) 1 performing automatic driving calculates a control route and determines a control method by a situation recognition process based on information input from the sensor map information group 20 and the vehicle motion information group 30, and notifies the control execution unit 40 of the determined control method, and the control execution unit 40 executes a vehicle operation based on the notified control method. Further, the automatic driving control device 10 is also assumed to evaluate a result of the control executed by the control execution unit 40. Incidentally, the automatic driving control device 10, the sensor map information group 20, the vehicle motion information group 30, and the control execution unit 40 function as automatic driving assistance devices.

The automatic driving control device 10 includes a situation recognition unit 11, a control determination unit 12, an experience information search unit 13, an experience information registration unit 14, and an experience information database 15, a control result evaluation unit 16, and a control route calculation unit 17.

The situation recognition unit 11 periodically receives a plurality of pieces of information from the sensor map information group 20 that generates sensor information and map information, such as a global positioning system (GPS) device 21, a laser, a peripheral sensor 22 such as a camera, a high-precision map system 23, and a navigation system 24 and the vehicle motion information group 30 that generates motion information of the vehicle, such as a steering angle sensor 31, a vehicle speed sensor 32, and a gyro sensor 33, integrates the respective received pieces of information to calculate information on a peripheral situation including a state of a host vehicle, and notifies the control determination unit 12 and the control route calculation unit 17 of the calculated information as situation recognition information. Further, the situation recognition unit 11 notifies the control route calculation unit 17 of navigation route information received from the navigation system 24 of the sensor map information group 20.

When a route has been set by the navigation route information, the control route calculation unit 17 has a function of re-determining (calculating) a route adapted to an automatic control function (automatic control function mounted on the automatic driving control device 10), the route enabling safe and stable automatic control, as a new control route based on the situation recognition information received from the situation recognition unit 11, and notifying the control determination unit 12 of information on the re-determined control route as control route information. Further, the control route information includes information on a recommendation degree, and the control route calculation unit 17 notifies the control determination unit 12 of the control route information including the information on the recommendation degree. When receiving the situation recognition information from the situation recognition unit 11, the control route calculation unit 17 extracts an ID of a control experience distribution information table 300 to be described later based on the received situation recognition information, as an ID serving as a search key configured to search for experience information stored in the experience information database 15, and notifies the experience information search unit 13 of information on the ID of the control experience distribution information table 300 to be described later. Incidentally, the extracted ID serves as a search key configured to allow the experience information search unit 13 to search for a function achievement value in response to the sensor map information group 20 from a road shape position information table 400, a lane shape position information table 500, and an environment details information table 700, which are stored in the experience information database 15 to be described later.

The experience information search unit 13 searches for the experience information in the experience information database 15 using the search key notified from the control route calculation unit 17, and notifies the control route calculation unit 17 of, for example, function information, environment information, time information, and the function achievement value as the experience information obtained by the search. The control route calculation unit 17 calculates a control route (automatic control route) in response to a function of the vehicle and a recommendation degree thereof based on the sensor map information group 20 and the function achievement value corresponding to the sensor map information group 20, and notifies the control determination unit 12 of the calculated result.

The control determination unit 12 functions as a control method information generation unit that determines a control method for safe travel on the control route based on the situation recognition information received from the situation recognition unit 11 and the control route and recommendation degree calculated by the control route calculation unit 17, and notifies the control execution unit 40 and the control result evaluation unit 16 of information on the control method as control method information. For example, the control determination unit 12 determines a control method for control the automatic driving vehicle 1 to execute each of a plurality of functions on the control route, the control method for controlling the automatic driving vehicle 1 to travel in a stable state on the control route, and notifies the control execution unit 40 of information on the determined control method as control method information. At this time, when a recommendation degree on a target control route is determined to be low or when it is determined that the control method is hardly determined by a control determination process, the control determination unit 12 notifies the control authority management unit 42 of transfer of a control authority to a user, and cancels the automatic driving travel.

Further, the control determination unit 12 notifies the control result evaluation unit 16 of information indicating that automatic driving travel is to be canceled in the case of canceling the automatic driving travel without being capable of calculating the control method according to a control method determination process or in the case of canceling the automatic driving travel by being notified of a user's request on transfer of the control authority from the control authority management unit 42 when the control execution unit 40 has executed stop control based on the control method information notified by the control determination unit 12.

The experience information search unit 13 has a function of searching the control experience distribution information table 300 stored in the experience information database 15 using the situation recognition information received from the control route calculation unit 17 as a search key, and notifying the control route calculation unit 17 and the control result evaluation unit 16 of a function achievement value specified by the search key. Further, when receiving situation recognition information on area information that needs to be evaluated from the control result evaluation unit 16, the experience information search unit 13 also has a function of searching the control experience distribution information table 300 stored in the experience information database 15 using the received situation recognition information as a search key, and notifies the control result evaluation unit 16 of a function achievement value specified by the search key.

The experience information registration unit 14 has a function of executing registration and update of a new entry of evaluation result information from the control result evaluation unit 16 to a table (the control experience distribution information table 300, the road shape position information table 400, the lane shape position information table 500, a control function response route information table 600, and the environment details information table 700) stored in the experience information database 15.

The experience information database 15 is a database in which experience information reflecting execution results of a plurality of functions during automatic driving travel of the automatic driving vehicle 1, the experience information registered in the various tables, in association with situation recognition information. In the experience information database 15, pieces of information registered in the control experience distribution information table 300, the road shape position information table 400, the lane shape position information table 500, the control function response route information table 600, and the environment details information table 700 are stored as information of the various tables as will be described later.

The control result evaluation unit 16 notifies the experience information search unit 13 of information to be evaluated (a road ID group of the road shape position information table 400 and a lane ID group of the lane shape position information table 500), and acquires information corresponding to a road ID and a lane ID from among the information recorded in the control experience distribution information table 300 from the experience information search unit 13. When the control determination unit 12 receives situation recognition information that is identical to information on the recommendation degree (a recommended control route) notified from the control route calculation unit 17 from the situation recognition unit 11 regarding the information to be evaluated, the control result evaluation unit 16 holds the received situation recognition information. When receiving control method information from the control execution unit 40, the control result evaluation unit 16 holds the received control method information in association with the situation recognition information. Further, when receiving notification on termination of experience information registration from the experience information registration unit 14, the control result evaluation unit 16 creates information of the control function response route information table 600 in which a control method for controlling the automatic driving vehicle 1 to travel on a route between two points is registered, based on the held control method information. The control result evaluation unit 16 associates information in the environment details information table 700 with information in the control experience distribution information table 300 to calculate a function achievement value 307, and manages the calculation result as evaluation result information.

The evaluation result information is information on a control result of a control function to control the automatic driving vehicle 1 to travel on a route between two points. The control route calculation unit 17 calculates a recommended control route based on the function achievement value 307 in response to a host vehicle position specified by the situation recognition information, a destination specified by the navigation system 24, map information obtained from the high-precision map system 23, and notifies the control determination unit 12 of recommended control route information on the calculated recommended control route. The control determination unit 12 calculates a control method according to the control method determination process to execute the control function based on the situation recognition information and the recommended control route information, and notifies the control execution unit 40 of control method information on the calculated control method. When it is difficult to determine the control method by the control determination process, the control determination unit 12 notifies the control authority management unit 42 of handover of the control authority to the user, and cancels the automatic driving travel. In this case, the control execution unit 40 notifies the control result evaluation unit 16 that the automatic driving travel is to be canceled. On the other hand, when there is no entry of the function achievement value 307 in the control experience distribution information table 300, the control route calculation unit 17 notifies the control determination unit 12 that there is no entry.

When the route according to the navigation route information from the navigation system 24 is set as a control route, the control determination unit 12 performs the control method determination process for travel on this control route to calculate a control method, and notifies the control execution unit 40 of control method information on the calculated control method. At this time, when the control execution unit 40 has determined that a host vehicle position can be held on a target route by the received control method, the control execution unit 40 notifies the control result evaluation unit 16 of information indicating that the vehicle position can be held. At this time, the control result evaluation unit 16 calculates a function achievement value based on the notified information. Further, when the control execution unit 40 has determined that it is difficult to hold the host vehicle position on the target route by the received control method, the control execution unit 40 notifies the control result evaluation unit 16 of information indicating that it is difficult to hold the vehicle position.

The control execution unit 40 executes an operation of the automatic driving vehicle 1 based on the control method information received from the control determination unit 12 and operation information received from the manual control unit 41. For example, the control execution unit 40 controls an operation unit such as a brake, an accelerator, and a steering wheel based on the control method information to execute automatic traveling of the automatic driving vehicle 1. Further, the control execution unit 40 notifies the control result evaluation unit 16 of a result of execution of control for each function as control result information.

The manual control unit 41 notifies the control execution unit 40 of the operation information based on a manual operation of steering, the accelerator/brake, or the like to be operated by the user.

The control authority management unit 42 has a function of notifying the control determination unit 12 of a request on start and cancellation of automatic driving travel from the user, and notifying the user of the cancellation of the automatic driving based on a request from the notification control determination unit 12.

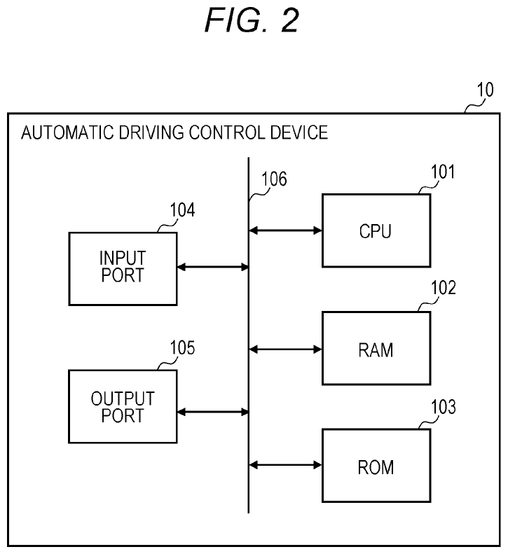

FIG. 2 is a physical configuration diagram of the automatic driving control device. In FIG. 2, the automatic driving control device 10 is constituted by a central processing unit (CPU) 101, a random access memory (RAM) 102, a read only memory (ROM) 103, an input port 104, an output port 105, and a bus 106 connecting these parts. The CPU 101 is configured as a central processing unit or a controller that comprehensively controls the entire operation of the automatic driving control device. The RAM 102 and the ROM 103 are storage devices configured using storage media. The input port 104 is connected to an input device such as a keyboard and a mouse, and the output port 105 is connected to an output device such as a display and a printer.

The CPU 101 executes various programs stored in the storage device, for example, a situation recognition program, a control determination program, an experience information search program, an experience information registration program, and a control result evaluation program. At this time, the CPU 101 executes each of the situation recognition program, the control determination program, the experience information search program, the experience information registration program, the control route calculation program, and the control result evaluation program, thereby realizing each function of the situation recognition unit 11, the control determination unit 12, the experience information search unit 13, the experience information registration unit 14, the control result evaluation unit 16, and the control route calculation unit 17. Incidentally, the experience information database 15 is stored in the storage device.

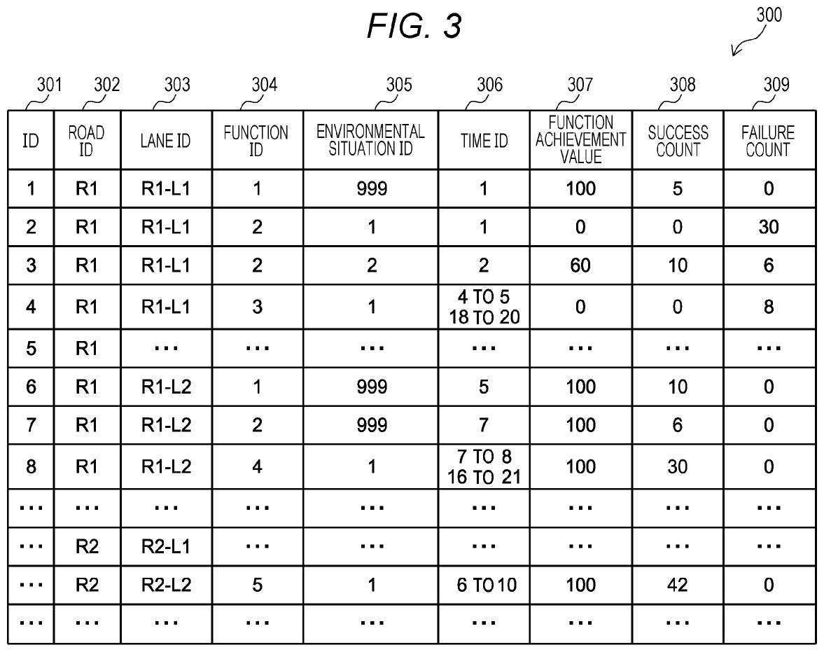

FIG. 3 is a configuration diagram illustrating a configuration example of the control experience distribution information table. In FIG. 3, the control experience distribution information table 300 includes an ID 301, a road ID 302, a lane ID 303, a function ID 304, an environmental situation ID 305, a time ID 306, the function achievement value 307, a success count 308, and a failure count 309. The control experience distribution information table 300 is a table on which information representing adaptability of the automatic control function of the automatic driving vehicle 1 on a traveling road or lane is recorded. The ID 301 is an identifier for uniquely identifying an entry, and an ID to specify the entry is registered in the ID 301. The road ID 302 is an identifier for uniquely identifying a road for calculation of a control route. For example, information of “R1” is recorded in the road ID 302 as the identifier for identifying the road. The lane ID 303 is an identifier for uniquely identifying a lane for calculation of a control route. In the lane ID, for example, information of “R1-L1” is recorded as the identifier for identifying the lane.

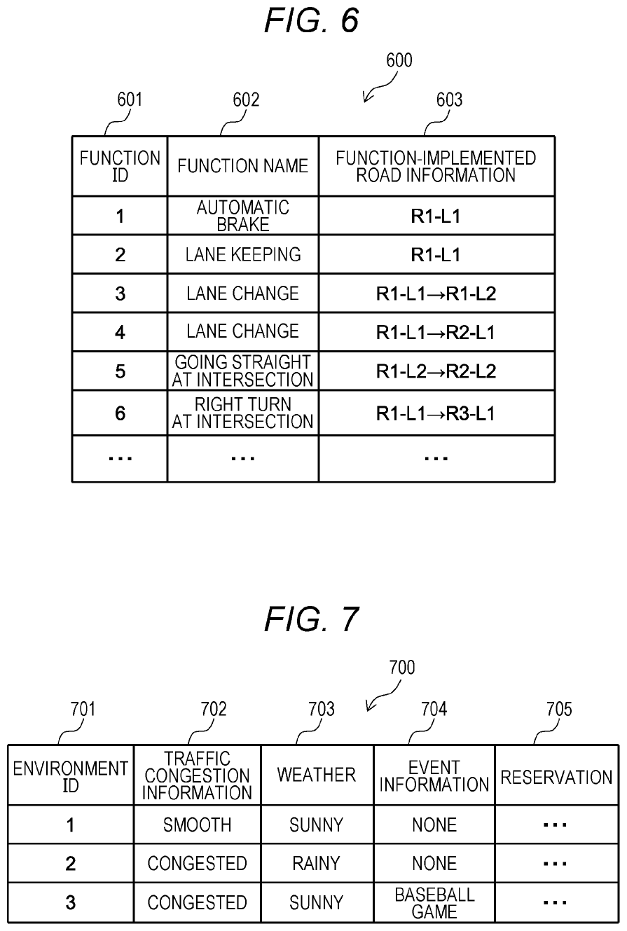

The function ID 304 is an ID linked to a function ID 601 of the control function response route information table 600 of FIG. 6. It is possible to search function-implemented route information 603 in response to a control function (function name) of the automatic driving vehicle 1 with the corresponding ID. When specifying an entry, the ID is registered as a new ID.

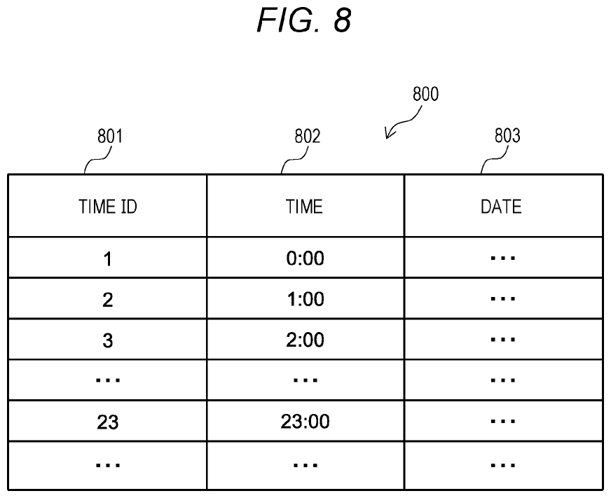

The environmental situation ID 305 is an ID linked to an environment ID 701 of the environment details information table 700 of FIG. 7. It is possible to search environment information (traffic congestion information and weather) during travel of the automatic driving vehicle 1 with the corresponding ID. When specifying an entry, the ID is registered as a new ID.

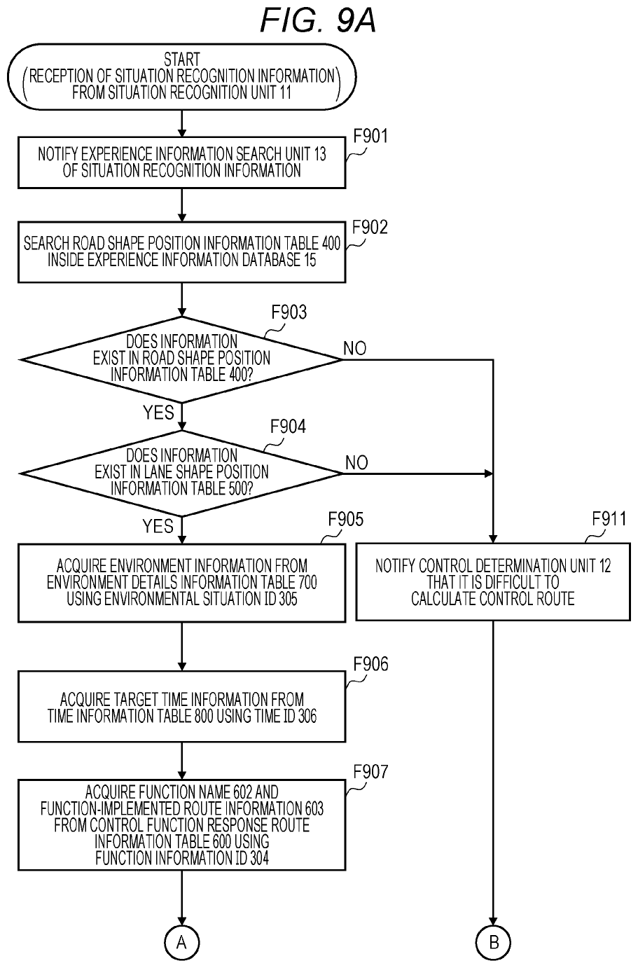

The time ID 306 is an ID linked at the time ID 801 of the time information table 800 of FIG. 8. The time ID 306 represents a time section regarding the function achievement value 307. When specifying an entry, the ID is registered as a new ID.

The function achievement value 307 is a value representing a success rate of control for a function name (a function name 602 of the control function response route information table 600) linked to the function ID 304, and is calculated whenever the success count 308 and the failure count 309 are updated. For example, when a success rate of control for an automatic brake, which is one of the functions mounted on the automatic driving vehicle 1, is 100%, information of “100” is registered in the function achievement value 307. The success count 308 represents a value that is counted when the automatic driving vehicle 1 has fully implemented the automatic control (function). For example, when the number of times the automatic driving vehicle 1 has fully implemented the automatic control is five times, information of “5” is registered in the success count 308. The failure count 309 represents a value that is counted when the automatic driving vehicle 1 fails to implement the automatic control. For example, when the number of times the automatic driving vehicle 1 has failed to implement the automatic control is 30 times, information of “30” is registered in the failure count 309.

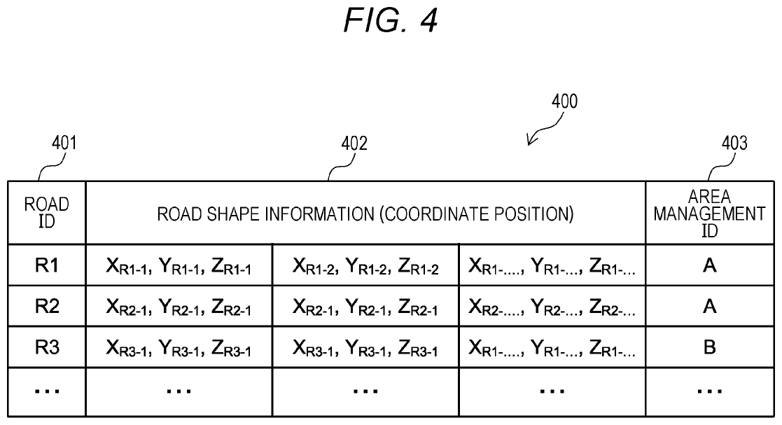

FIG. 4 is a configuration diagram illustrating a configuration example of the road shape position information table. In FIG. 4, the road shape position information table 400 includes a road ID 401, road shape information (a coordinate position) 402, and an area management ID 403. The road ID 401 is a unique ID representing a road, and is registered as a new ID when specifying an entry. The road shape information (coordinate position) 402 is shape information representing a road shape, and three-dimensional coordinates of “X1, Y1, and Z1” are registered in the road shape information (coordinate position) 402. Further, it is also possible to register information obtained by functionalization of a road shape in the road shape information (coordinate position) 402 if necessary. When high-precision map information (including a road) is output from the high-precision map system 23 to the situation recognition unit 11, such pieces of information on the road shape are used as information for matching whether the corresponding road exists in the experience information database 15 with respect to the experience information search unit 13 performed by the control route calculation unit 17. The road shape information (coordinate position) 402 is registered as new information when specifying an entry.

The area management ID 403 is management information to specify a road at high speed. The area management ID 403 is desirably managed in cooperation with the high-precision map information (including the road) of the high-precision map system 23. The area management ID 403 is registered as a new ID when specifying an entry.

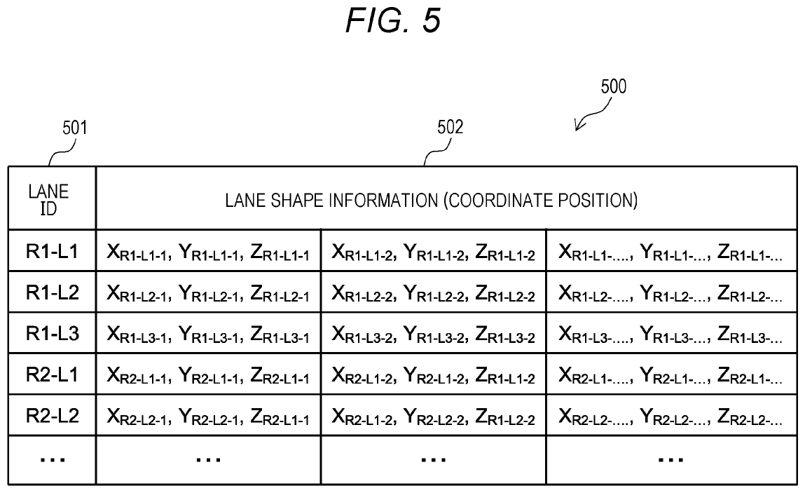

FIG. 5 is a configuration diagram illustrating a configuration example of the lane shape position information table. In FIG. 5, the lane shape position information table 500 includes a lane ID 501 and lane shape information (a coordinate position) 502. The lane ID 501 is an ID linked to the lane ID 303 of the control experience distribution information table 300 of FIG. 3 and is a unique ID representing a lane. The lane ID 501 is registered as a new ID when specifying an entry. The lane shape information (coordinate position) 502 is shape information representing a lane shape, and three-dimensional coordinates of “X1, Y1, and Z1” are registered in the lane shape information (coordinate position) 502. Further, it is also possible to register information obtained by functionalization of a lane shape in the lane shape information (coordinate position) 502 if necessary. The lane shape information (coordinate position) 502 is registered as a new ID when specifying an entry.

FIG. 6 is a configuration diagram illustrating a configuration example of the control function response route information table. In FIG. 6, the control function response route information table 600 includes the function ID 601, a function name 602, and the function-implemented route information 603. The function ID 601 is a unique ID representing a function (control function) mounted on the automatic driving vehicle 1 and is registered as a new ID when specifying an entry. The function name 602 is information indicating a name of a function (control function) mounted on the automatic driving vehicle 1. For example, when the function of “automatic brake” is mounted on the automatic driving vehicle 1, information of “automatic brake” is registered in the function name 602. The function-implemented route information 603 is information on a route on which a function mounted on the automatic driving vehicle 1 has implemented control for the function name 602. In the function-implemented route information 603, information on a road or a lane of the road is registered as the route information on the route when the function mounted on the automatic driving vehicle 1 has implemented control. For example, when the function of “automatic brake” has been implemented on a lane “L1” of a road “R1”, information of “R1-L1” is registered in the function-implemented route information 603. When a function mounted on the automatic driving vehicle 1 has been implemented on a new route, route information on the new route is registered in the function-implemented route information 603.

FIG. 7 is a configuration diagram illustrating a configuration example of the environment details information table. In FIG. 7, the environment details information table 700 is a table configured by combining various pieces of travel environment information, and includes the environment ID 701, a traffic congestion information 702, a weather 703, event information 704, and a reservation 705. The environment ID 701 is a unique ID representing a travel environment of the automatic driving vehicle 1 and is registered as a new ID when specifying an entry. The traffic congestion information 702 is information indicating the degree of traffic congestion (smooth or congested). The weather 703 is information representing a climate (for example, sunny or rainy). The event information 704 is information representing an event (for example, a baseball game) held in a periphery of a road. The reservation 705 is an expanded region configured to store information on other travel environments.

FIG. 8 is a configuration diagram illustrating a configuration example of the time information table. In FIG. 8, the time information table 800 includes the time ID 801, a time 802, and a date 803. The time ID 801 is a unique ID representing a time. The time 802 is information representing each time of 24 hours a day. The date 803 is information representing a calendar date to which each time of 24 hours a day belongs.

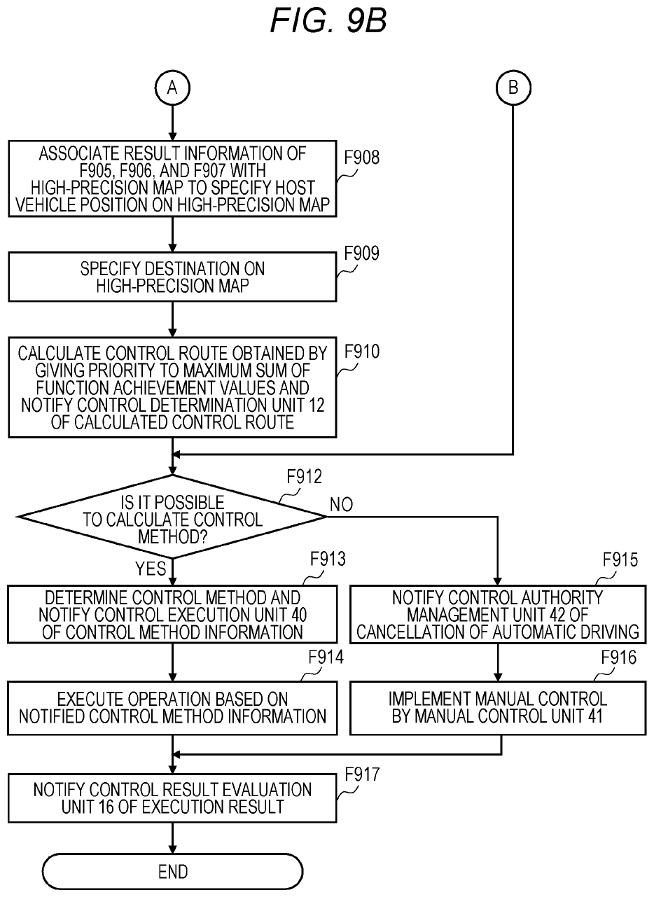

Hereinafter, a description will be given regarding processing in which the control route calculation unit 17 receives situation recognition information periodically output from the situation recognition unit 11 and notifies the experience information search unit 13 of the received situation recognition information in a normal state where the automatic driving vehicle 1 executes automatic driving travel, the experience information search unit 13 extracts experience information from the experience information database 15, and the control route calculation unit 17 calculates a control route based on the extracted experience information, according to flowcharts illustrated in FIGS. 9A and 9B.

In FIG. 9A, first, this processing is started as the control route calculation unit 17 receives the situation recognition information from the situation recognition unit 11. This situation recognition information includes information obtained as a result of recognizing a peripheral situation of the automatic driving vehicle 1 such as host vehicle position information and high-precision map information specified by the high-precision map system 23, destination information designated by a user operating the navigation system 24, and information from the GPS device 21, the peripheral sensor 22, and various sensors belonging to the vehicle motion information group 30.

When receiving the situation recognition information from the situation recognition unit 11, the control route calculation unit 17 notifies the experience information search unit 13 of the received situation recognition information (F901). Next, the experience information search unit 13 searches the road shape position information table 400 in the experience information database 15 using the received situation recognition information as a search key (F902), and determines whether the corresponding information exists in the road shape position information table 400 (F903).

Specifically, when road shape information (a coordinate position) exists in the received situation recognition information, the experience information search unit 13 searches the road shape position information table 400 using the road shape information (coordinate position) as a search key, and determines whether information corresponding to the search key exists (determines whether a road having the same road shape exists) in the road shape information (coordinate position) 402 of the road shape position information table 400. When obtaining an affirmative determination result in Step F903, the experience information search unit 13 acquires information of the road ID 401 from the road shape position information table 400, and then, determines whether the corresponding information exists (determines whether a lane having the same lane shape exists) in the lane shape position information table 500 (F904). When a negative determination result is obtained in Step F903, the processing proceeds to Step F911.

In Step F904, when lane shape information (a coordinate position) exists in the received situation recognition information, the experience information search unit 13 searches the lane shape position information table 500 using the lane shape information (coordinate position) as a search key, and determines whether information corresponding to the search key exists in the lane shape information (coordinate position) 502 of the lane shape position information table 500. When an affirmative determination result is obtained in Step F904, the experience information search unit 13 acquires information of the lane ID 501 from the lane shape position information table 500, and then, the processing proceeds to Step F905. When a negative determination result is obtained in Step F904, the processing proceeds to Step F911.

If information corresponding to the search key is specified in Steps F903 and F904, this specification does not mean to seek exact matching of coordinate positions but means relative matching through comparison between relative coordinate positions or shape states.

In Step F905, the experience information search unit 13 refers to the control experience distribution information table 300 based on the information of the road ID 401 acquired in Step F903 and the information of the lane ID 501 acquired in Step F904 to acquire information of the road ID 302 and the lane ID 303 corresponding to the road ID 401 and the lane ID 501 from control experience distribution information table 300, and refers to the environment details information table 700 based on the environmental situation ID 305 specified by the acquired information of the road ID 302 and the lane ID 303 to acquire environment information specified by the environmental situation ID 305 from the environment details information table 700.

For example, when “R1” has been acquired as the information of the road ID 401 in Step F903 and “R1-L1” has been acquired as the information of the lane ID 501 in Step F904, the experience information search unit 13 acquires “999”, “1”, “2” and “1” as the information of the environmental situation ID 305 from the control experience distribution information table 300, and acquires “smooth” and “congested” in the traffic congestion information 702, “sunny” and “rainy” in the weather 703, and “none” and “none” in the event information 704 from the environment details information table 700 as the environment information in response to the acquired information (“1” and “2”) of the environmental situation ID 305.

Next, the experience information search unit 13 refers to the control experience distribution information table 300 based on the information of the road ID 401 acquired in Step F903 and the information of the lane ID 501 acquired in Step F904 to acquire information of the road ID 302 and the lane ID 303 corresponding to the road ID 401 and the lane ID 501 from control experience distribution information table 300, and refers to the time information table 800 based on the time ID 306 specified by the acquired road ID 302 and lane ID 303 to acquire target time information specified by the time ID 306 from the time information table 800 (F906).

Next, the experience information search unit 13 refers to the control experience distribution information table 300 based on the information of the road ID 401 acquired in Step F903 and the information of the lane ID 501 acquired in Step F904 to acquire the information of the road ID 302 and the lane ID 303 corresponding to the road ID 401 and the lane ID 501 from control experience distribution information table 300, and refers to the control function response route information table 600 based on the function ID 304 specified by the acquired road ID 302 and lane ID 303 to acquire the function name 602 and the function-implemented route information 603 specified by the function ID 304 from the control function response route information table 600 (F907).

For example, when “R1” has been acquired as the information of the road ID 401 in Step F903 and “R1-L1” has been acquired as the information of the lane ID 501 in Step F904, the experience information search unit 13 acquires “1”, “2”, “2”, and “3” from the control experience distribution information table 300 as the information of the function ID 304, acquires “automatic brake”, “lane keeping”, and “lane change” as the information of the function name 602 from the control function response route information table 600 based on the information “1”, “2”, and “3” of the function ID 601 specified by the acquired information of the function ID 304, and acquires “R1-L1”, “R1-L1”, and “R1-L1→R1-L2” as the information of the function-implemented route information 603.

Next, as illustrated in FIG. 9B, the control route calculation unit 17 takes search results of the experience information search unit 13 and links the processing results of Steps F905, F906, and F907 to a high-precision map to specify a host vehicle position on the high-precision map (F908), specifies a destination specified by the navigation system 24 on the high-precision map (F909), and then, calculates a control route obtained by giving priority to the maximum sum of the function achievement values 307 specified by the road ID 302 and the lane ID 303 and notifies the control determination unit 12 of the calculation result (F910). At this time, the control route calculation unit 17 calculates the control route obtained by giving priority to the function achievement value 307 in response to the corresponding road or lane, for example, using attributes for searching the high-precision map (for example, the number of traffic lights or intersections and a width of a road).

On the other hand, when a negative determination result is obtained in Step F903 and F904 as illustrated to FIG. 9A, that is, when there is no road or lane having the same shape as the road designated by the search key in the experience information database 15, the experience information search unit 13 notifies the control route calculation unit 17 of the negative determination result. At this time, the control route calculation unit 17 notifies the control determination unit 12 that it is difficult to calculate a control route (F911).

As illustrated in FIG. 9B, the control determination unit 12 determines whether a control method can be calculated based on the calculation result of the control route calculation unit 17 and the processing result of Step F911 (F912).

When obtaining an affirmative determination result in Step F912, the control determination unit 12 determines a control method based on the calculation result of the control route calculation unit 17, and notifies the control execution unit 40 of control method information on the determined control method (F913). At this time, the control execution unit 40 executes an operation based on the control method information notified from the control determination unit 12 (F914).

On the other hand, when obtaining a negative determination result in Step F912, the control determination unit 12 notifies the control authority management unit 42 of cancellation of the automatic driving (F915). At this time, the manual control unit 41 implements manual control in accordance with an instruction from the control authority management unit 42 (F916), and the processing proceeds to Step F917.

Next, the control execution unit 40 notifies the control result evaluation unit 16 of an execution result of the control method (F917), and ends the processing in this routine.

With the above-described processing, it is possible to calculate a control route including a road or a lane with a high function achievement value as a route for executing a function of the automatic driving vehicle 1. Further, when the control route is calculated, by considering the environment information and time information, it is possible to calculate a control route that matches the environment and time when the automatic driving vehicle 1 travels automatically.

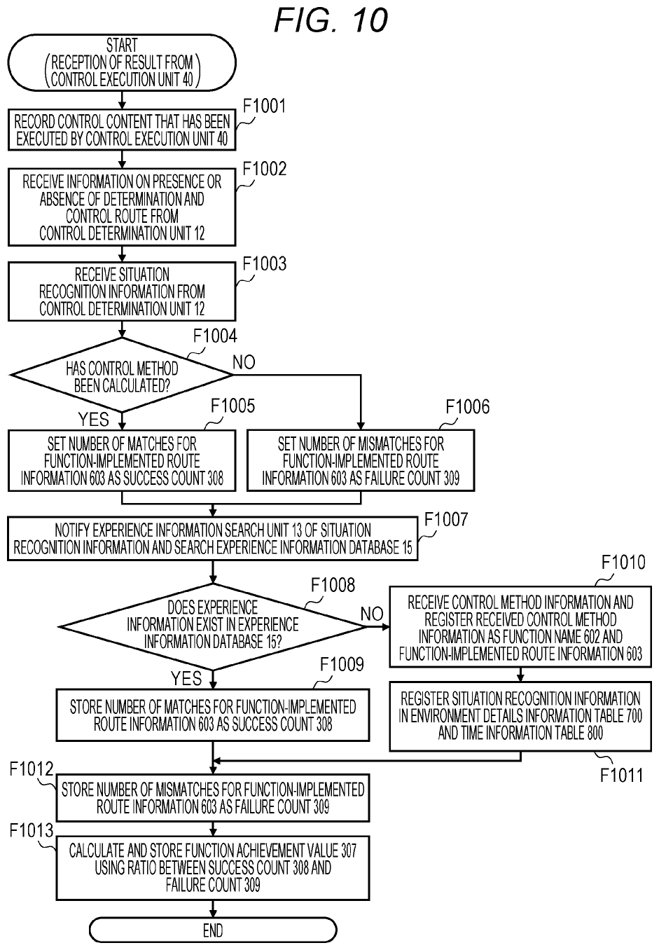

Next, processing of the automatic driving control device 10 when the control result evaluation unit 16 determines transition to an experience information registration state will be described according to a flowchart illustrated in FIG. 10.

This processing is started on a condition that the control result evaluation unit 16 receives a control result from the control execution unit 40. First, the control result evaluation unit 16 records control content (content of a control method) that has been executed by the control execution unit 40 (F1001), then, receives information on presence or absence of determination (presence or absence of control method determination) and information on a control route from the control determination unit 12 (F1002), and receives situation recognition information (information including a road, a lane, or the like) from the control determination unit 12 (F1003).

Next, the control result evaluation unit 16 determines whether the control determination unit 12 has calculated a control method (F1004), and sets the number of matches (the number of successes) as the success count 308 (F1005) when an affirmative determination result is obtained in Step F1004, that is, when the control method has been calculated since this result means that a control route for which the control execution unit 40 has executed the control method matches a route registered in the function-implemented route information 603 of the control function response route information table 600.

On the other hand, the control result evaluation unit 16 sets the number of mismatches (the number of failures) as the failure count 309 (F1006) when a negative determination result is obtained in Step F1004, that is, when it is difficult to calculate the control method since this result means that the control route for which the control execution unit 40 has executed the control method does not match the route registered in the function-implemented route information 603 of the control function response route information table 600.

Next, the control result evaluation unit 16 notifies the experience information search unit 13 of the situation recognition information received in Step F1003, and the experience information search unit 13 searches the experience information database 15 using the received situation recognition information as a search key (F1007).

Next, the experience information search unit 13 determines whether experience information corresponding to the search key exists in the experience information database 15 (F1008), and notifies the experience information registration unit 14 and the control execution unit 40 of the determination result via the control result evaluation unit 16.

When receiving a determination result that the experience information corresponding to the search key exists in the experience information database 15 from the experience information search unit 13, the experience information registration unit 14 stores the number of times the situation recognition information (information including a road and a lane) received in Step F1003 matches the route registered in the function-implemented route information 603 of the control function response route information table 600, as success count information, in the success count 308 of the control experience distribution information table 300 (F1009).

On the other hand, when it is determined in Step F1008 that the experience information corresponding to the search key does not exist in the experience information database 15, the experience information registration unit 14 receives control method information that has been executed by the manual control unit 41 via the control execution unit 40 and the control result evaluation unit 16, and registers the received control method information as the function name 602 and the function-implemented route information 603 of the control function response route information table 600 (F1010). Thereafter, the experience information registration unit 14 registers the situation recognition information (information including an environment and a time) received in Step F1003 in the environment details information table 700 and the time information table 800 (F1011), and stores the number of times the situation recognition information received in Step F1003 does not match the route registered in the function-implemented route information 603 of the control function response route information table 600, as failure count information, in the failure count 309 of the control experience distribution information table 300 (F1012).

Next, the experience information registration unit 14 calculates a function achievement value using a ratio between the success count 308 and the failure count 309, stores information of the calculation result in the function achievement value 307 of the control experience distribution information table 300, and updates the function achievement value 307 (F1013). Thereafter, the experience information registration unit 14 ends the processing in this routine. Since the function achievement value 307 is updated, it is possible to calculate a control route that is more adapted to a function of the automatic driving vehicle 1 when the control route is calculated next.

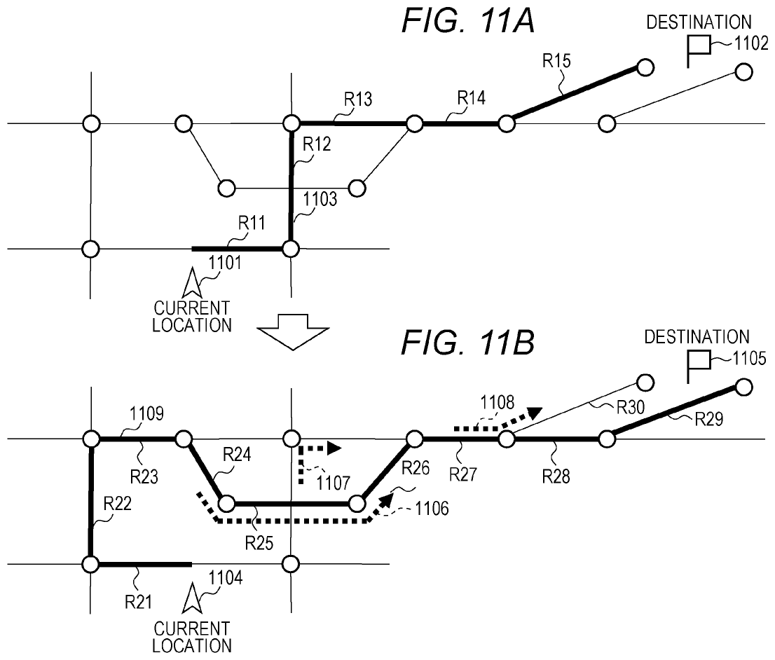

FIGS. 11A and 11B are travel route views illustrating setting examples of a travel route depending on presence or absence of use of the experience information database. FIG. 11A is a travel route view illustrating a setting example of a travel route when the experience information database is not used, and FIG. 11B is the travel route view illustrating a setting example of a travel route of the automatic driving system according to the first embodiment of the invention.

In the case of not using information of the experience information database 15 as illustrated in FIG. 11A, if a user inputs information of a destination 1102, the navigation system 24 normally selects a shortest travel route 1103, the route including roads R11, R12, R13, R14, and R15, based on road types, lengths of road links, and the like as a travel route from a current location 1101 to the destination 1102 and presents the selected travel route 1103 to the user. At this time, when the roads R12 and R13 belong to a route where it is difficult to automatically turn right and right-turning accidents frequently occur, it is assumed that it is difficult to continue automatic driving in a stable state if the automatic driving vehicle 1 travels along this route using a function mounted thereon.

Therefore, the present embodiment is configured such that a route where an automatic driving vehicle 1 has succeeded in automatic driving is stored in advance in the experience information database 15, the automatic driving control device 10 refers to the experience information database 15 based on situation recognition information to calculate a control route at the time of starting travel and presents a travel route according to the calculated control route to the user as illustrated in FIG. 11B.

For example, when the user inputs the information of the destination 1105 at the current location 1104, the automatic driving control device 10 refers to the experience information database 15 based on situation recognition information at the current location 1104 to calculate a control route, and presents a travel route according to the calculated control route to the user. For example, a travel route 1106 with a lane having a wide width and a continuously travelable lane, the route including roads R21, R22, R23, R24, R25, R26, R27, R28, and R29, is selected as the travel route from the current location 1104 to the destination 1105, and presented to the user. The travel route 1106 includes a road applicable to a car lane keeping function.

The automatic driving control device 10 can perform stable automatic control by preferentially using the car lane keeping function in the control route calculation. Since a route 1107 where it is difficult to automatically turn right and right-turning accidents frequently occur and a route 1108 where automatic merging from a branch lane is difficult due to a traffic congestion in the morning and evening are routes hardly adapted to the automatic control function, the automatic driving control device 10 executes a process of excluding these routes as much as possible during the control route calculation so that the stable automatic control becomes possible. Further, when travel to the destination 1105 using the travel route 1106 has been performed, such a successful experience is registered in the experience information database 15 as a function achievement value. When the destination 1105 is set at the current location 1104, the automatic driving control device 10 can calculate a route 1109 in consideration of an automatic control route at the current location 1104, and present the route 1109 to the user as an initial route.

According to the present embodiment, it is possible to calculate the control route adapted to the function of the automatic driving vehicle 1 based on the experience information reflecting the execution result of the function during the automatic driving travel of the automatic driving vehicle 1. That is, an adaptation situation of safety assistance or the automatic driving function in response to a road situation is accumulated as the experience information, and a route in consideration of a difficulty of the automatic driving function is calculated from the accumulated experience information, whereby it is possible to select a route where the automatic driving travel is easy, as a control route, in advance before travel. Further, it is possible to reduce a restriction on execution of the function (automatic driving function) in the selected route, and as a result, stable and continuous automatic driving travel can be realized.

### Second Embodiment

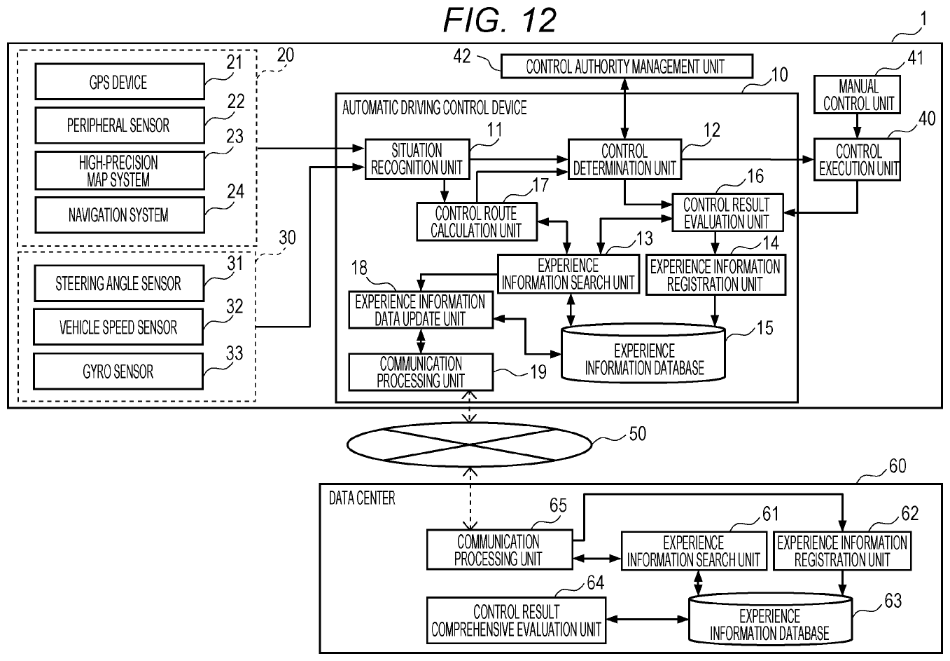

Hereinafter, a second embodiment of the invention will be described with reference to FIG. 12. A difference between the present embodiment and the first embodiment is that an experience information database is installed not only in the automatic driving vehicle 1 but also in a data center, and the automatic driving vehicle executes automatic driving travel while communicating with the data center. In this case, all vehicles share the experience information database of the data center. As a merit, it becomes possible to provide each vehicle with experience information that does not exist in an experience information database in its own vehicle from the data center, and a control route calculation unit can calculate a more accurate control route.

FIG. 12 is a configuration diagram illustrating a configuration example of an automatic driving system according to the second embodiment. With respect to the configuration of the automatic driving system of the first embodiment, the automatic driving system of the second embodiment is configured such that an experience information data update unit 18 and a communication processing unit 19 are added to the automatic driving control device 10, a data center 60 including an experience information database 63, an experience information search unit 61, an experience information registration unit 62, a control result comprehensive evaluation unit 64, and a communication processing unit 65 is added, and the communication processing unit 19 of the automatic driving control device 10 and the communication processing unit 65 of the data center 60 are connected via a communication network 50.

The communication processing unit 19 and the communication processing unit 65 perform processing to implement data communication between the automatic driving vehicle 1 and the data center 60 via the communication network 50.

The experience information database 63 is a database storing information of various tables (the control experience distribution information table 300, the road shape position information table 400, the lane shape position information table 500, the control function response route information table 600, and the environment details information table 700) in which experience information reflecting execution results of a plurality of functions (automatic driving functions) during automatic driving travel of a plurality of automatic driving vehicles different from the host vehicle (automatic driving vehicle 1) has been recorded.

When experience information (road information, lane information, control route information, environment information, or the like) corresponding to situation recognition information received from the control route calculation unit 17 does not exist in the experience information database 15, the experience information search unit 13 inquires the experience information data update unit 18 with the situation recognition information received from the control route calculation unit 17. When receiving an inquiry from the experience information search unit 13, the experience information data update unit 18 notifies the data center 60 of content of the inquiry via the communication processing unit 19 and the communication network 50. The content to be notified is, for example, information of the road shape information (coordinate position) 402 or the lane shape information (coordinate position) 502.

When the communication processing unit 65 of the data center 60 receives the notification from the communication processing unit 19, the communication processing unit 19 notifies the experience information search unit 61 of the content of the received notification. The experience information search unit 61 searches for the road shape information (coordinate position) 402 or the lane shape information (coordinate position) 502 in the experience information database 63 using the received notification content (information of the road shape information (coordinate position) 402 or the lane shape information (coordinate position) 502) as a search key, extracts experience information (function information, control route information, time information, and the like specified by the road or the lane) corresponding to the search key from the control experience distribution information table 300, and notifies the communication processing unit 65 of the extracted experience information. The communication processing unit 65 transmits the notification content received from the experience information search unit 61 to the communication processing unit 19 via the communication network 50.

The communication processing unit 19 transfers the experience information received from the communication processing unit 65 to the experience information data update unit 18. The experience information data update unit 18 updates information of the experience information database 15 based on the received experience information. As a result, the information in the control experience distribution information table 300 is updated among the experience information in the experience information database 15. The control route calculation unit 17 can generate a control route using the updated information of the control experience distribution information table 300.

Meanwhile, the control result evaluation unit 16 generates a function achievement value based on a control result of the control execution unit 40, and registers information of the generated function achievement value in the control experience distribution information table 300 of the experience information database 15 via the experience information registration unit 14. The experience information data update unit 18 transmits experience information registered in the experience information database 15 to the communication processing unit 65 of the data center 60 via the communication processing unit 19 and the communication network 50. The communication processing unit 65 notifies the experience information registration unit 62 of the received experience information. The experience information registration unit 62 registers the notified experience information (the road shape information (coordinate position) 402, the lane shape information (coordinate position) 502, the function name 602, the function-implemented route information 603, the traffic congestion information 702, the weather 703, the event information 704, the time 802, and the date 803) in the experience information database 63. In this case, the control result comprehensive evaluation unit 64 re-calculate a function achievement value using information of all the success counts 308 and the failure counts 309 among the information of the experience information database 63, and registers the re-calculated function achievement value in the function achievement value 307 of the control experience distribution information table 300.

According to the present embodiment, the experience information that does not exist in the experience information database 15 can be provided from the data center 60 to the experience information database 15, and thus, the control route calculation unit 17 can calculate a more accurate control route. Experience information obtained utilizing experiences during automatic driving travel of various automatic driving vehicles is accumulated the experience information database 63 of the data center 60, and the experience information is shared among vehicles having the same function via the data center 60 serving as a cloud. Thus, even when the automatic driving vehicle 1 travels on an inexperienced road that does not exist in the experience information database 15, it is possible to more reliably calculate a control route in response to the automatic driving function by utilizing experience information of other automatic vehicles having the same function if the experience information of other automatic vehicles having the same function exists in the experience information database 63. As a result, it is possible to reduce the cancellation of automatic driving unexpected by the user.

Incidentally, the invention is not limited to the above-described embodiments and includes various modifications. For example, the automatic driving control device 10 and the control execution unit 40 can be integrated to form a controller. At this time, the controller controls automatic driving of a vehicle, for example, based on sensor information indicating peripheral information of the vehicle (automatic driving vehicle 1) performing the automatic driving, map information including a travel route of the vehicle, and motion information indicating a state of the vehicle. Further, the control route calculation unit 17 and the experience information search unit 13 can be integrated, or the control route calculation unit 17, the experience information search unit 13 and the experience information data update unit 18 can be integrated. Further, the control result evaluation unit 16 and the experience information registration unit 14 can be integrated. The above-described embodiments have been described in detail in order to describe the invention in an easily understandable manner, and are not necessarily limited to those including the entire configuration that has been described above. Further, some configurations of a certain embodiment can be substituted by configurations of another embodiment, and further, a configuration of another embodiment can be also added to a configuration of a certain embodiment. Further, addition, deletion, or substitution of other configurations can be made with respect to some configurations of each embodiment.

Further, a part or all of each of the above-described configurations, functions, and the like may be realized, for example, by hardware by designing with an integrated circuit and the like. Further, each of the above-described configurations, functions, and the like may also be realized by software by causing a processor to interpret and execute a program for realizing each of the functions. The information, such as a program, a table, and a file, to implement each function can be recorded in a recording device, such as a memory, a hard disk, and a solid state drive (SSD), or a recording medium such as an integrated circuit (IC) card, a secure digital (SD) card, and a digital versatile disc (DVD).

What is claimed is:

1. An automatic driving assistance device comprising:
a situation recognition unit which calculates situation recognition information on a peripheral situation of a vehicle based on sensor information indicating information on a periphery of the vehicle performing automatic driving, map information including a travel route of the vehicle, and motion information indicating a state of the vehicle;
an experience information database which includes information on at least a plurality of functions, a function achievement value indicating an achievement degree of each of the plurality of functions, and a road on which each of the plurality of functions has been executed, as experience information reflecting execution results of the plurality of functions during automatic driving travel of the vehicle, and in which the experience information is recorded in association with the situation recognition information;
an experience information extraction unit which searches the experience information database based on the situation recognition information calculated by the situation recognition unit, and extracts the experience information corresponding to the situation recognition information from the experience information database;
a control route calculation unit which calculates a control route including the road of which the function achievement value is high, the route being a route when executing at least one of the plurality of functions based on the experience information extracted by the experience information extraction unit;
a control determination unit which determines a control method for controlling the vehicle to execute at least one of the plurality of functions on the control route calculated by the control route calculation unit, and generates control method information on the determined control method; and
a control execution unit which operates the vehicle based on the control method information generated by the control determination unit to execute the automatic driving of the vehicle.

2. The automatic driving assistance device according to claim 1, further comprising
a communication processing unit which transmits and receives information via a communication network to and from a data center that manages a data center experience information database in which experience information reflecting execution results of a plurality of functions during automatic driving travel of a plurality of automatic driving vehicles different from a host vehicle has been recorded in association with the situation recognition information,
wherein the control route calculation unit searches the data center experience information database via the communication processing unit when the experience information corresponding to the situation recognition information does not exist in the experience information database, and extracts the experience information corresponding to the situation recognition information from the data center experience information database.

3. The automatic driving assistance device according to claim 2, wherein
the control route calculation unit extracts the experience information of a function identical to a function mounted on the host vehicle when extracting the experience information corresponding to the situation recognition information from the data center experience information database.

4. The automatic driving assistance device according to claim 1, further comprising
a control result evaluation unit which evaluates an execution result of the control execution unit, and updates the function achievement value out of the experience information recorded in the experience information database based on the evaluated result.

5. The automatic driving assistance device according to claim 1, wherein
in the experience information database, environment information indicating an environmental situation of the periphery of the vehicle and time information indicating a time when the vehicle has traveled are recorded as information belonging to the experience information in association with the situation recognition information, and
the control route calculation unit searches the experience information database based on the situation recognition information calculated by the situation recognition unit, extracts the experience information corresponding to the situation recognition information from the experience information database, and calculates a control route including the road of which the function achievement value is high, and specified by the environment information and the time information, the route being a route when executing at least one of the plurality of functions based on the extracted experience information.

6. An automatic driving assistance method provided with a controller, which controls automatic driving of a vehicle based on sensor information indicating information on a periphery of the vehicle performing the automatic driving, map information including a travel route of the vehicle, and motion information indicating a state of the vehicle, the method comprising:
a situation recognition information calculation step of causing the controller to calculate situation recognition information on a peripheral situation of the vehicle based on the sensor information, the map information, and the motion information;
an experience information extraction step of causing the controller to search an experience information database, which includes information on at least a plurality of functions, a function achievement value indicating an achievement degree of each of the plurality of functions, and a road on which each of the plurality of functions has been executed, as experience information reflecting execution results of the plurality of functions during automatic driving travel of the vehicle, and in which the experience information is recorded in association with the situation recognition information based on the situation recognition information calculated in the situation recognition information calculation step, and to extract the experience information corresponding to the situation recognition information from the experience information database;
a control route calculation step of causing the controller to calculate a control route including the road of which the function achievement value is high, the route being a route when executing at least one of the plurality of functions based on the experience information extracted in the experience information extraction step;
a control determination step of causing the controller to determine a control method for controlling the vehicle to execute at least one of the plurality of functions on the control route calculated in the control route calculation step, and to generate control method information on the determined control method; and
a control execution step of causing the controller to operate the vehicle based on the control method information generated in the control determination step to execute the automatic driving of the vehicle.

7. The automatic driving assistance method according to claim 6, wherein
a communication processing unit, which transmits and receives information via a communication network to and from a data center having a data center experience information database in which experience information reflecting execution results of a plurality of functions during automatic driving travel of a plurality of automatic driving vehicles different from a host vehicle has been recorded in association with the situation recognition information, is provided, and
wherein, in the experience information extraction step, the controller searches the data center experience information database via the communication processing unit when the experience information corresponding to the situation recognition information does not exist in the experience information database, and extracts the experience information corresponding to the situation recognition information from the data center experience information database.

8. The automatic driving assistance method according to claim 7, wherein
in the experience information extraction step, the controller extracts the experience information of a function identical to a function mounted on the host vehicle when extracting the experience information corresponding to the situation recognition information from the data center experience information database.

9. The automatic driving assistance method according to claim 6, further comprising
an experience information update step of causing the controller to evaluate an execution result in the control execution step, and to update the function achievement value out of the experience information recorded in the experience information database based on the evaluated result.

10. The automatic driving assistance method according to claim 6, wherein
in the experience information database, environment information indicating an environmental situation of the periphery of the vehicle and time information indicating a time when the vehicle has traveled are recorded as information belonging to the experience information in association with the situation recognition information,
in the experience information extraction step, the controller extracts the experience information corresponding to the situation recognition information from the experience information database based on the situation recognition information calculated in the situation recognition information calculation step, and
in the control route calculation step, the controller calculates a control route including the road of which the function achievement value is high and specified by the environment information and the time information, the route being a route when executing at least one of the plurality of functions based on the experience information extracted in the experience information extraction step.
